(19) United States
(12) Patent Application Publication
(10) Pub. No.: US 2009/0152879 A1
(43) Pub. Date: Jun. 18, 2009

(54) CABINET AND LATCH

(76) Inventor: Malgorzata Pala, Burr Ridge, IL (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/954,854

(22) Filed: Dec. 12, 2007

(51) Int. Cl. A47B 81/00; E05C 17/02

(52) U.S. Cl. 292/305; 312/319.1

(57) ABSTRACT

A cabinet having one or more doors is disclosed. The doors include a latch mechanism. The latch mechanism disclosed includes a single or multiple linkages between a latch slide and one or more multiple rods which move to latch the doors in a closed position.

The present invention relates to a cabinet, such as may be used to store weapons or other items, and also to various types of latches used to latch the cabinet closed.

### BACKGROUND

Various cabinets and various latches are known. One such example is set forth in publication No. US2007/0188058A1 showing a cabinet with mesh bi-fold doors. There is a need for an improved latch system, providing secure latching, and preferably providing simple and reliable movement of the components.

### SUMMARY

The present invention provides an improved latch. The claims, and only the claims, define the invention.

The present invention may include a cabinet with at least one door, slidable latch, one or more linkages connected to the latch, and one or more rods connected to the linkage. Once the latch is moved, it causes the linkages to move the rods to latch the door shut as set forth in the claims.

One object of the present invention is to provide a device to an improved latch.

### DESCRIPTION OF THE DRAWING FIGURES

FIG. 1 is a perspective inside view showing one example of latch components;

FIG. 2 is a view of components of FIG. 1 and also showing two vertical rods;

FIG. 3A is an inside perspective of one example of a door with one example of a latch mechanism;

FIG. 3B is a perspective detail of an upper portion of FIG. 3A;

FIG. 3C is another perspective view detailing a portion of FIG. 3A;

FIG. 4 is a perspective view of one example of a cabinet;

FIG. 5 is a perspective view of an example of a door in isolation with the latch in a latched position;

FIG. 5A is a detail of the latch mechanism of FIG. 5;

FIG. 6 is a perspective view of a door in isolation with the latch in an unlatched position;

FIG. 6A is a detailed view of the latch mechanism of FIG. 6;

FIG. 7 is a perspective detail of an outside view of one example of a latch;

FIG. 8 is a side view, in isolation, of one example of a latch slide and two linkages;

FIG. 9 is an alternative arrangement of latch slide and linkages; and

FIG. 10 is another alternative arrangement of a latch slide and linkages.

### BRIEF DESCRIPTION OF THE PREFERRED EMBODIMENT

For the purposes of promoting an understanding of the principles, reference will now be made to the embodiments illustrated herein and specific language will be used to describe the same. It will nevertheless be understood that no limitation of the scope of the invention is thereby intended. Any alterations and further modifications in the described processes, systems or devices, any further applications of the principles of the invention as described herein, are contemplated as would normally occur to one skilled in the art to which the invention relates, now and/or in the future.

As used in the claims and the specification, the following terms have the following definitions:

The term “cabinet” includes any closet, compartment, or other vessel for storage or holding other articles, including without limitation free standing structures as well as partial structures built in to a building or vehicle.

The term “latch” means any mechanism (mechanical, magnetic, or otherwise) which tends to maintain a door in a closed position with or without a lock.

The term “vertical” means the direction of gravity plus or minus 30 degrees, particularly including such orientation when the cabinet is positioned for its normal intended use.

The term “rod” is any single member or multiple members connected together which is longer than it is in width or cross section. The term rod includes solid members, hollow members, porous members, trusts structures, straight members, curved members, and may include any cross section including round, oval, square, rectangular, triangular or otherwise.

The term “linkage” is any structure that mechanically links to other structures together for purposes of movement. This includes members that act in tension, compression, or both, and is not limited to any particular geometry, and may include elongated members, round members, straight members, curved members, and may be made from any non-fluid material.

The term “pivot connection” is any location in which one element is connected (directly or indirectly) to another element and may, at least in some situations, pivot with respect with each other. This includes structures in which the pivot is made integrally to one or both the members, as well as where the pivot is by one or more third members, such as a rivet, pin, hinge or otherwise.

The term “protrusion” is any geometric extension which allows, or at least facilitates, manual engagement of the protrusion for purposes of movement.

The term “mesh structure” is any structure, such as part of a door and/or cabinet, which at least for a localized area is at least 20 percent porous. It can be formed by stamping or forming holes or other apertures in to sheet metal or other material, by inter-weaving rod or mesh, by bars, or otherwise.

The term “inboard” means toward the mid-line M, whereas “outboard” means away from the mid-line M.

The language used in the claims is to only have its plain and ordinary meaning, except as explicitly defined above. Such plain and ordinary meaning is inclusive of all consistent dictionary definitions from the most recently published Webster's dictionaries and Random House dictionaries.

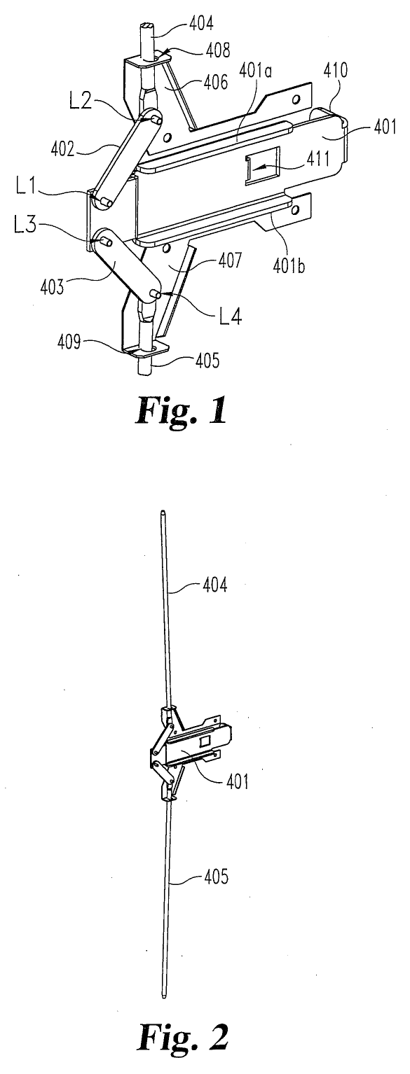

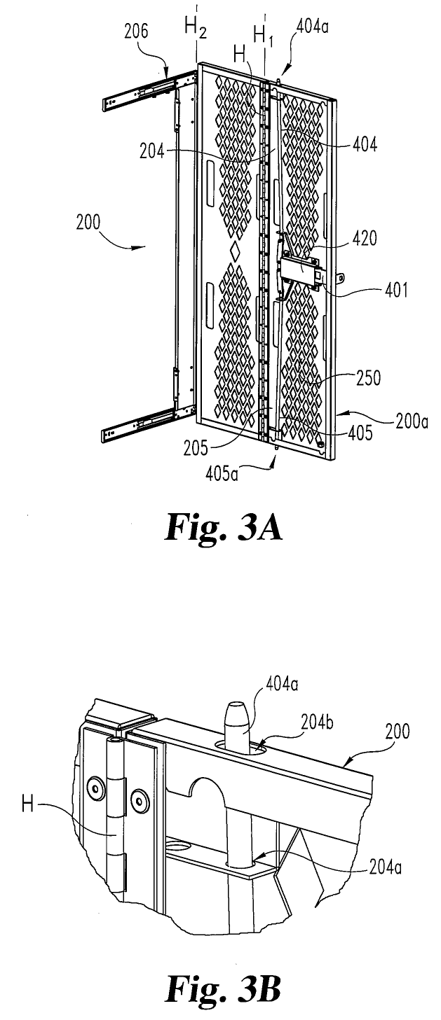

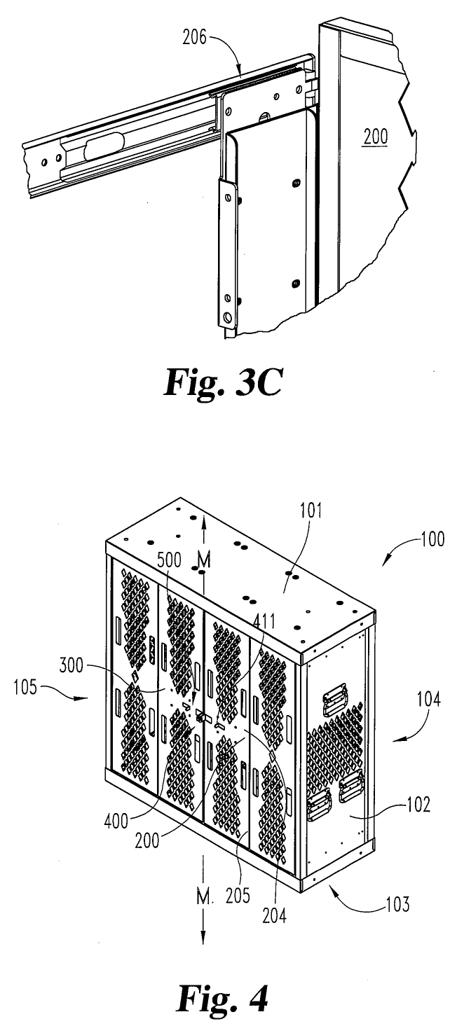

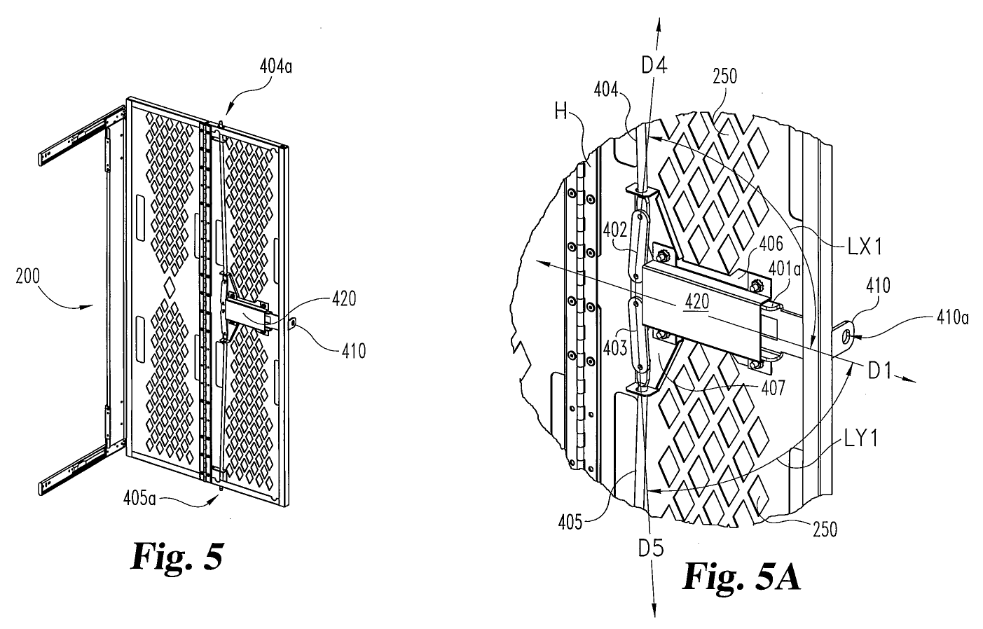

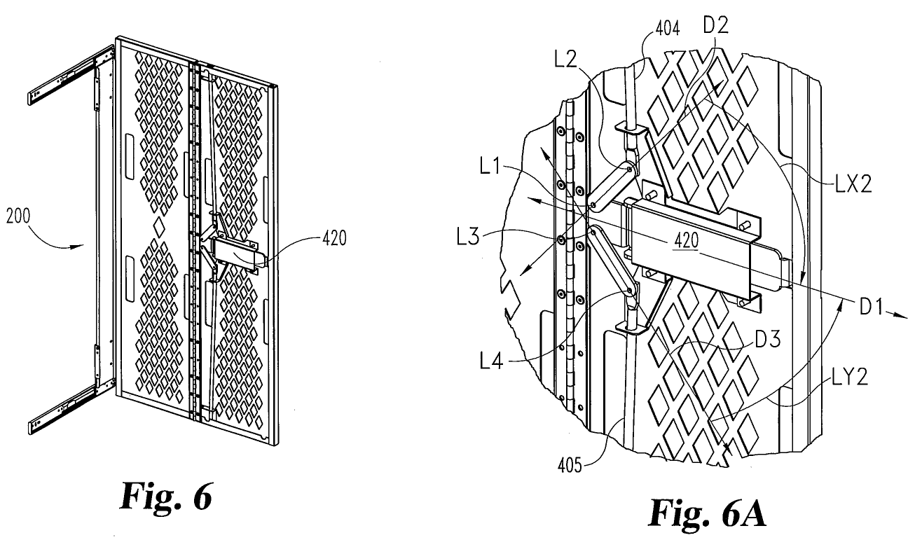

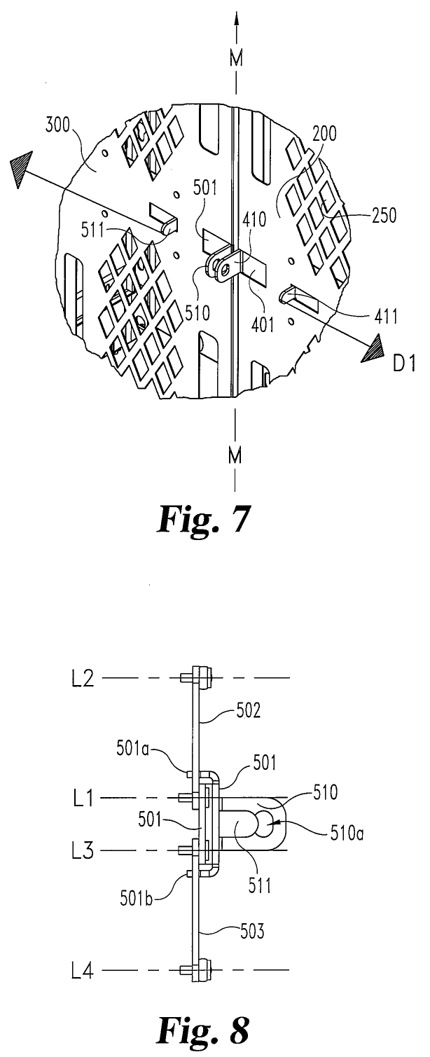

Referring to FIGS. 1-8, a cabinet 100 and one or more latch devices 400, 500, may include a cabinet 100 optionally having at least a left door 200 and a right door 300, wherein optionally the left door and the right door each have a free end (see e.g. 200 in FIG. 3A) that swings to a closed position (FIG. 4) with the free ends optionally being adjacent to each other along a vertical midline M (FIG. 7); optionally a linearly slidable left latch 401 on the left door that is slideable in a horizontal, linear direction D1 between a latched position (FIG. 5A) toward the midline and an unlatched position (FIG. 6A) away from the vertical midline; optionally a first-left vertical rod 404 slideable in a vertical direction between a latched position away from the left latch and an unlatched position toward the left latch; optionally a first-left linkage 402 with a pivot connection L1 to the left latch and a separate pivot connection L2 to the first-left vertical rod 404, wherein sliding of the left latch causes the first-left linkage to slide the first-left vertical rod; optionally a linearly slidable right latch on 501 said right door that is slideable in a horizontal, linear direction D1 between a latched position toward the midline M and an unlatched position away from the vertical midline; optionally a first-right vertical rod slideable in a vertical direction between a latched position away from the right latch and an unlatched position toward the right latch; optionally a first-right linkage optionally with a pivot connection R1 to the right latch and optionally a separate pivot connection R2 to the first-right vertical rod, wherein sliding of the right latch causes the first-right linkage to slide the first-right vertical rod.

Optionally a first protrusion 410 on the left latch 401 protrudes away from the cabinet 100 and provides a handle for linear sliding thereof; and, optionally a first protrusion on the right latch (see FIG. 4) that protruded away from the cabinet and provides a handle for linear sliding thereof. Optionally, the first protrusion and said second protrusion optionally each have a hole 410a therein to both optionally receive the shackle of a padlock (not shown) when the left latch and the right latch are slid in the latched position toward the midline M (see FIG. 7).

Optionally, one or several of the latch slides has a protrusion, such as protrusion 410 along with another protrusion, such as protrusion 411, on the same slide and spaced therefrom, preferably spaced outboard and preferable spaced far enough apart to allow a user, even if wearing heavy gloves, to pull on protrusion 411 (and protrusion 511) outboard to unlatch the latch.

Optionally, when the left latch is in the unlatched position (FIG. 6A), a line D2 projected between said pivot connection L1 and the pivot connection L2 is optionally oriented at an angle LX2 with respect to the direction D1 of linear sliding of the left latch that is greater than 30 degrees and less than 60 degrees. Optionally said left latch 401 cannot rotate and optionally said right latch 501 cannot rotate. Angle LX2 may be about 45 degrees in the fully unlatched position. Cabinet 100 optionally includes a weapons rack therein for optionally supporting several firearms or other weapons. The doors 200 optionally comprises a mesh structure (such as with openings like mesh opening 250 in FIG. 5A) optionally allowing substantial ventilation and visibility of an inside of the cabinet.

Optionally, the first-left linkage 401 and the first-right linkage 403 both optionally are separate pieces from each other and optionally are movable independently from each other.

Optionally there may be second-left vertical rod 405 slideable in a vertical direction between a latched position (FIG. 5A) away from said left latch and an unlatched position (FIG. 6A) toward said left latch; and, optionally a second-left linkage 403 optionally with a pivot connection L3 to said left latch and optionally a separate pivot connection L4 to the second-left vertical rod 405, wherein sliding of the left latch causes the second-left linkage to slide the second-left vertical rod. Optionally a second-right vertical rod is slideable in a vertical direction between a latched position (FIG. 7) away from said right latch and an unlatched position toward said right latch; and, optionally may include a second-right linkage optionally with a pivot connection R3 to the right latch and optionally a separate pivot connection R4 to the second-right vertical rod, wherein sliding of the right latch causes the second-right linkage to slide the second-right vertical rod.

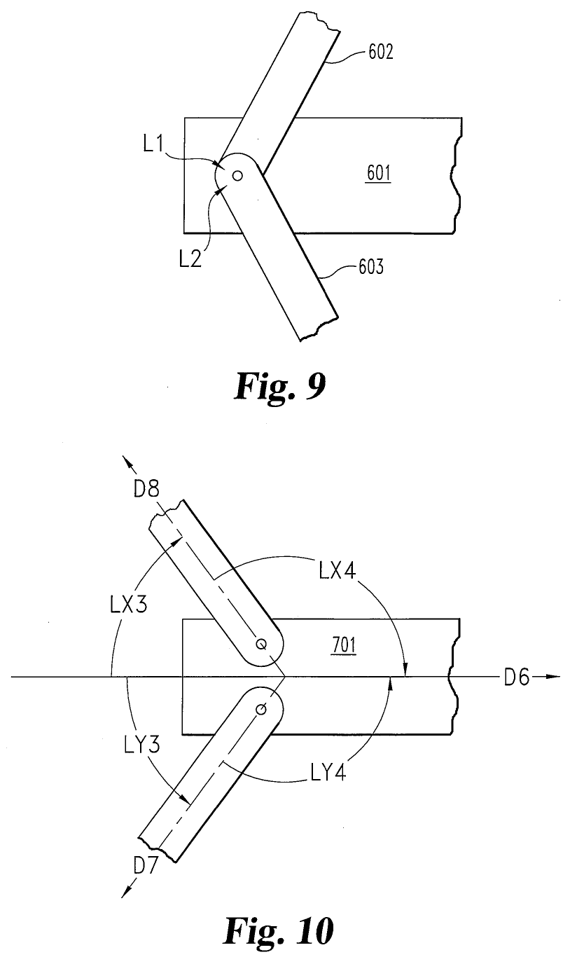

Optionally, pivot connections L1 and L3 optionally coincide (see FIG. 9) about a common axis, and wherein corresponding but separate pivot connections on an optional right side latch optionally coincide about another common axis.

The device may have a single door and a single latch, multiple doors and a single latch, and/or multiple doors with multiple latches. The one example shown in the drawings shows multiple doors with multiple latches. For brevity, most of the written description and drawing discussed above is in the context of the single latch, including latch 401 of the other components in the context of door 200. Otherwise, the one example shown is completely symmetric with the correspondence structure for latch 500 and door 300 (see FIG. 4). This particular example shows a bi-fold door in the left side and the right side. The device is not limited to bi-fold doors, and they include hinged doors, garage-type doors, and otherwise. The definition of a cabinet in the claims is set forth above. As set forth in FIG. 4, only one, non-limiting, example of a cabinet is shown as cabinet example 100 with a top 101, side 102, bottom 103, back 104 and front 105, and with a side opposite side 102 not shown in FIG. 4. The cabinet may be any shape or size. This particular example is shown with handles on the side, but is not limited to cabinets with handles on the side or with handles of any sort.

FIG. 3C is merely an example of door 200 in connection with a prior art element 206 which is a slide structure employed both in prior art cabinet doors as well as in the one, non-limiting example given in this written description. The invention is no way limited to slide 206 or any such slide, or any hinge mechanism.

Door 200 preferably includes a free edge 200a (see FIG. 3A). Such leading edge is not limited to a straight leading edge, leading edge on the side, and edge without other features, or otherwise. Door 300 similarly, as shown, has such a free edge optionally along midline M.

As shown in FIG. 3B, rod 404 preferably has a tip or distal end 404a which engages, protrudes into a receptacle or other hole or structure in the cabinet or building in which the door is placed to facilitate latching and/or locking. It is shown as somewhat frusto-conical, although this is purely optional, and any geometry may be used. As shown, the tip 404a is, the preferred example, protruding through opening 204b and is optionally guided by opening 204a. None of these features are strictly required, but are merely disclosed in the interest of completeness. Similarly, Rod 405 may include distal end 405a (see FIG. 3A and FIG. 5), and similarly is not limited.

Comparison of FIG. 5A and FIG. 6A illustrates one example, and only an example, of how the claimed latch may operate. FIG. 5 and FIG. 5A show the latch in the latched position, whereas FIG. 6 and FIG. 6A show the latch in an unlatched position. In the unlatched position, directional D2 is formed between pivot connection L1 and L2. Similarly, direction D1 is the slide direction of latch 401, preferably, but not necessarily, in a horizontal direction. Angle LX2 is the angle between Line D1 and D2, and preferably is greater than 30 degrees and less than 60 degrees, although may be a greater or lesser angle, and more preferably is about 45 degrees in the unlatched position. The relationship between Line D3 defined by pivot connection L3 and L4 and the corresponding angle LY2 between D3 and D1 is preferably similar to LX2. By comparison, with reference to FIG. 5A, direction line D5 is likewise defined by the pivot connections of linkage 403 defines a different angle, typically a larger angle, LY1 with respect to lines D1 and D5. Similarly, line D4, shown as the direction or line between the pivot points on linkage 402 definite angle LX1 with respect to direction D1. In the latched position (see e.g., FIG. 5A) angles LX1 and LY1 are each preferably between 45 degrees and 90 degrees, and as shown are slightly less than 90 degrees.

It should be noted in this particular example that sliding of latch 401 inboard pulls the outboard location of the latch, thereby exerting compression on the linkages 402 and 403 which in turn exert compression, or pushing, on rods 404 and 405. It is to be understood a latch mechanism does not require two linkages or two rods, but may also include one linkage and one rod, or more than two linkages and two rods. Similarly, any such structure may be included on a second or third doors such as in connection with latch 501 (see FIG. 7). Although latch 501 may be different, preferably it is substantially like 401. The same is true of its associated pieces. For example, as seen in FIG. 8, latch 501 optionally includes linkage 502 and linkage 503, optional protrusion 510, optional opening 510a (for receiving the shackle of a padlock), optional protrusion 511 (spaced outboard of protrusion 510), and pivot connections L1, L2, L3 and L4, similarly to that previously described regarding 401. Although certainly not required, slide or latch 501 (like slide or latch 401) may optionally have flanges, rails or extensions, such as 501a and/or 501b. This adds strength and stiffness to the latch slide 501.

Similarly, as shown in FIG. 5A, latch 401 may include such member 401a. This horizontal sliding of latch 401 preferably occurs in contact with guide 420 (see FIG. 5A). As but one example, guide 420 at least partially contains, confines or guides slide 401. Optionally, lubrication is provided between slide 401 and 420. This may take a variety of forms. The most preferred form, member 420, may be separately fabricated, and may be separately painted or otherwise coated with a lubrication, such as with paint including tetrafluoroethylene (Teflon®) or otherwise.

Similarly, with reference to FIG. 5A, member 406 and/or member 407 may be provided as guides for rod 404 and 405 respectively. As with member 420, members 406 and 407 may be painted or otherwise coated with such a lubrication material.

Thus, for example when slide 401 (or slide 501) is moved horizontally towards the midline M, the linked rods 404 and/or 405 move away from the latch 401, namely move in opposite vertical directions away from the axis D1. Conversely, as the latch 401 is moved to an unlatched position, the rods move inwardly towards latch 401 and line D1.

FIG. 9 illustrates another optional arrangement in which the latch slides 601 is pivotally connected to linkage 602 and linkage 603 pivot connections L1 and L2 wherein L1 and L2 coincide on the same pivot axis.

FIG. 10 also illustrates another arrangement where by the slide direction D6 of the sliding latch 701 has an obtuse angle LX4 with respect to the direction D8 of the linkage, and similarly where direction D6 has an obtuse angle LY4 with respect to direction D7 of the other optional linkage. As illustrated, angle LX3 is the supplementary, acute angle with respect to angle LX4; and, angle LY3 is the supplementary, acute angle with respect to obtuse angle LY4. In such situations, preferably the acute angles LX3 and LY3, are preferably but not necessarily between 30 and 60 degrees and more preferably about 45 degrees. In this arrangement, as shown in FIG. 10, sliding of the slide 701 to the right would exert tension on the linkage members (rather than compression) as is present in FIG. 6A. This arrangement may be utilized by inverting the arrangement of the rods in the latch position so that optionally sliding into the latch outboard causes latching movement of the rods, or vice versa. The separate pivot point shown in FIG. 10 may optionally be reconfigured with a coinciding pivot point arrangement such as shown in FIG. 9. Moreover, these arrangements may be hybridized, such as between 6A and FIG. 10 so that one or more linkages is any compression arrangement while one or more other linkages are in tension arrangements, or both.

For example, the tension arrangement of FIG. 10 can be such that sliding of the latch 701 away from the midline M is what moves the linkages, and correspondingly the rods, into a latched position, and conversely movement of the latched slide 701 towards the midline retracts the rods in a vertical direction into an unlatched position.

As illustrated in FIG. 3A, the optionally arrangement of a bi-fold door may have pivoting not only around axis H₂, but also around hinge axis H₁. Although these can be achieved in a variety of mechanical structures (hinges, pivots, or otherwise), as illustrated hinging about hinge axis H₁ may be achieved with hinge H. In this particular arrangement, while not required, FIG. 3A illustrates how vertical rod 404 is positioned closer to hinge axis H₁ than it is to the midline and/or free edge 200a of door 200. Alternatively, rods 404 and 405 could be positioned directly and evenly between the hinge and the midline/free edge, or alternatively could be positioned closer to the free edge 200a than hinge axis H₁.

The present invention contemplates modifications as would occur to those skilled in the art. It is also contemplated that processes embodied in the present invention can be altered, rearranged, substituted, deleted, duplicated, combined, or added to other processes as would occur to those skilled in the art without departing from the spirit of the present invention. In addition, the various stages, steps, procedures, techniques, phases, and operations within these processes may be altered, rearranged, substituted, deleted, duplicated, or combined as would occur to those skilled in the art. The articles “the”, “a” and “an” are not necessarily limited to mean only one, but rather are inclusive and open ended so as to include, optionally, multiple such elements.

We claim:

1. A cabinet and latch device, including:
A cabinet having at least a left door and a right door, wherein the left door and the right door each have a free end that swings to a closed position with said free ends being adjacent to each other along a vertical midline;
A linearly slidable left latch on said left door that is slideable in a horizontal, linear direction between a latched position toward said midline and an unlatched position away from said vertical midline;
A first-left vertical rod slideable in a vertical direction between a latched position away from said left latch and an unlatched position toward said left latch;
A first-left linkage with a pivot connection L1 to said left latch and a separate pivot connection L2 to said first-left vertical rod, wherein sliding of said left latch causes said first-left linkage to slide said first-left vertical rod;
A linearly slidable right latch on said right door that is slideable in a horizontal, linear direction between a latched position toward said midline and an unlatched position away from said vertical midline;
A first-right vertical rod slideable in a vertical direction between a latched position away from said right latch and an unlatched position toward said right latch;
A first-right linkage with a pivot connection R1 to said right latch and a separate pivot connection R2 to said first-right vertical rod, wherein sliding of said right latch causes said first-right linkage to slide said first-right vertical rod.

2. The device of claim 1, and further including:
A first protrusion on said left latch that protruded away from the cabinet and provides a handle for linear sliding thereof;
A second protrusion on said right latch that protruded away from the cabinet and provides a handle for linear sliding thereof; and,
Wherein said first protrusion and said second protrusion each have a hole therein to both receive the shackle of a padlock when said left latch and said right latch are slid in the latched position toward said midline.

3. The device of claim 2 wherein when said left latch is in said unlatched position, a line projected between said pivot connection L1 and said pivot connection L2 is oriented at an angle LX with respect to the direction of linear sliding of said left latch that is greater than 30 degrees and less than 60 degrees.

4. The device of claim 3 wherein said left latch cannot rotate and wherein said right latch cannot rotate.

5. The device of claim 4 wherein said cabinet may store weapons.

6. The device of claim 5 wherein said at least one of said doors comprises a mesh structure allowing substantial ventilation and visibility of an inside of said cabinet.

7. The device of claim 6 wherein said first-left linkage and said first-right linkage both are separate pieces from each other and are movable independently from each other.

8. The device of claim 7, and further including:
A second-left vertical rod slideable in a vertical direction between a latched position away from said left latch and an unlatched position toward said left latch;
A second-left linkage with a pivot connection L3 to said left latch and a separate pivot connection L4 to said second-left vertical rod, wherein sliding of said left latch causes said second-left linkage to slide said second-left vertical rod;
A second-right vertical rod slideable in a vertical direction between a latched position away from said right latch and an unlatched position toward said right latch;
A second-right linkage with a pivot connection R3 to said right latch and a separate pivot connection R4 to said second-right vertical rod, wherein sliding of said right latch causes said second-right linkage to slide said second-right vertical rod.

9. The device of claim 8 wherein:
said left door comprises a left inboard door panel and a left outboard door panel connected to each along a left hinge axis;
wherein said first-left vertical rod is positioned closer to said left hinge axis than to a free edge of said inboard door panel.

10. The device of claim 9 wherein said first-right vertical rod and said second-right vertical rod are located behind and are shielded from tampering by said right door, and wherein said first-left vertical rod and said second-left vertical rod are located behind and are shielded from tampering by said left door.

11. The device of claim 10 wherein when said right latch is in said unlatched position, a line projected between said pivot connection R1 and said pivot connection R2 is oriented at an angle RX with respect to the direction of linear sliding of said right latch of about 45 degrees, and wherein when said right latch is in said unlatched position, a line projected between said pivot connection R3 and said pivot connection R4 is oriented at an angle RY with respect to the direction of linear sliding of said right latch that about 45 degrees, and wherein when said left latch is in said unlatched position, a line projected between said pivot connection L3 and said pivot connection L4 is oriented at an angle LY with respect to the direction of linear sliding of said left latch of about 45 degrees, and wherein said angle LX is about 45 degrees.

12. The device of claim 1 wherein when said left latch is in said unlatched position, a line projected between said pivot connection L1 and said pivot connection L2 is oriented at an angle LX with respect to the direction of linear sliding of said left latch that is greater than 30 degrees and less than 60 degrees.

13. The device of claim 1 wherein said left latch cannot rotate and wherein said right latch cannot rotate.

14. The device of claim 1 wherein said cabinet may store weapons.

15. The device of claim 1 wherein said at least one of said doors comprises a mesh structure allowing substantial ventilation and visibility of an inside of said cabinet.

16. The device of claim 1 wherein said first-left linkage and said first-right linkage both are separate pieces from each other and are movable independently from each other.

17. The device of claim 1, and further including:
A second-left vertical rod slideable in a vertical direction between a latched position away from said left latch and an unlatched position toward said left latch;
A second-left linkage with a pivot connection L3 to said left latch and a separate pivot connection L4 to said second-left vertical rod, wherein sliding of said left latch causes said second-left linkage to slide said second-left vertical rod;
A second-right vertical rod slideable in a vertical direction between a latched position away from said right latch and an unlatched position toward said right latch;
A second-right linkage with a pivot connection R3 to said right latch and a separate pivot connection R4 to said second-right vertical rod, wherein sliding of said right latch causes said second-right linkage to slide said second-right vertical rod.

18. The device of claim 17 wherein:
said left door comprises a left inboard door panel and a left outboard door panel connected to each along a left hinge axis;
wherein said first-left vertical rod is positioned closer to said left hinge axis than to a free edge of said inboard door panel.

19. The device of claim 17 wherein said first-right vertical rod and said second-right vertical rod are located behind and are shielded from tampering by said right door, and wherein said first-left vertical rod and said second-left vertical rod are located behind and are shielded from tampering by said left door.

20. The device of claim 17 wherein when said right latch is in said unlatched position, a line projected between said pivot connection R1 and said pivot connection R2 is oriented at an angle RX with respect to the direction of linear sliding of said right latch of about 45 degrees, and wherein when said right latch is in said unlatched position, a line projected between said pivot connection R3 and said pivot connection R4 is oriented at an angle RY with respect to the direction of linear sliding of said right latch that about 45 degrees, and wherein when said left latch is in said unlatched position, a line projected between said pivot connection L3 and said pivot connection L4 is oriented at an angle LY with respect to the direction of linear sliding of said left latch of about 45 degrees, and wherein said angle LX is about 45 degrees.

21. A cabinet and latch device, including:
A cabinet having at least a first door, wherein the door has a free end that swings to a closed position;
A linearly slidable latch on said door that is slideable in a horizontal, linear direction between a latched position and an unlatched position;
A first vertical rod slideable in a vertical direction between a latched position away from said latch and an unlatched position toward said latch;
A first linkage with a pivot connection P1 to said latch and a separate pivot connection P2 to said first-left vertical rod, wherein sliding of said latch causes said first linkage to slide said first-left vertical rod.

22. A second vertical rod slideable in a vertical direction between a latched position away from said latch and an unlatched position toward said latch;
A second linkage with a pivot connection P3 to said latch and a separate pivot connection P4 to said second vertical rod, wherein sliding of said latch causes said second linkage to slide said second vertical rod.

23. The device of claim 22 wherein when said latch is in said unlatched position, a line projected between said pivot connection P1 and said pivot connection P2 is oriented at an angle with respect to the direction of linear sliding of said left latch that is greater than 30 degrees and less than 60 degrees;
And wherein when said latch is in said unlatched position, a line projected between said pivot connection P3 and said pivot connection P4 is oriented at an angle with respect to the direction of linear sliding of said left latch that is greater than 30 degrees and less than 60 degrees.

24. The device of claim 21 wherein said latch cannot rotate.

25. The device of claim 23 wherein said latch cannot rotate.

26. The device of claim 21 wherein pivot connections P1 and P3 coincide about a common axis.

27. A cabinet and latch device, including:
A cabinet having at least a left door and a right door, wherein the left door and the right door each have a free end that swings to a closed position with said free ends being adjacent to each other along a vertical midline;
A linearly slidable left latch on said left door that is slideable in a horizontal direction between a latched position toward said midline and an unlatched position away from said vertical midline;
A linearly slidable right latch on said right door that is slideable in a horizontal direction between a latched position toward said midline and an unlatched position away from said vertical midline;
A first protrusion on said left latch that protruded away from the cabinet and provides a handle for linear sliding thereof;
A second protrusion on said right latch that protruded away from the cabinet and provides a handle for linear sliding thereof;
Wherein said first protrusion and said second protrusion each have a hole therein to both receive the shackle of a padlock when said left latch and said right latch are slid in the latched position toward said midline;
A third protrusion on said left latch and spaced outboard of said first protrusion; and,
A fourth protrusion on said right latch and spaced outboard of said second protrusion.

28. The device of claim 27 wherein said left latch and said right latch each are coupled to at least one rod for latching of the doors.

29. The device of claim 28 wherein said left latch and said right latch cannot rotate.
